(19) United States
(12) Patent Application Publication
(10) Pub. No.: US 2025/0039063 A1
(43) Pub. Date: Jan. 30, 2025

(54) Task-Aware Information Hiding

(71) Applicant: MediaTek Inc., Hsinchu City (TW)

(72) Inventors: Pedram Kheirkhah Sangdeh, San Jose, CA (US); Gyu Bum Kyung, San Jose, CA (US)

(21) Appl. No.: 18/784,044

(22) Filed: Jul. 25, 2024

Related U.S. Application Data
(60) Provisional application No. 63/515,844, filed on Jul. 27, 2023.

(51) Int. Cl. H04L 41/16; G06N 20/00; H04W 12/03; H04W 24/02

(52) U.S. Cl. CPC H04L 41/16; G06N 20/00; H04W 12/03; H04W 24/02

(57) ABSTRACT

Techniques pertaining to task-aware information hiding artificial intelligence/machine learning (AI/ML) models used in wireless communications are described. An apparatus performs task-aware information hiding or partial task-aware information hiding using an information hiding AI/ML model to embed information in a host data as a container. The apparatus then communicates with a network using the container which contains the embedded information.

### CROSS REFERENCE TO RELATED PATENT APPLICATION(S)

The present disclosure claims the priority benefit of U.S. Patent Application No. 63/515,844, filed 27 Jul. 2023, the content of which herein being incorporated by reference in its entirety.

### TECHNICAL FIELD

The present disclosure is generally related to artificial intelligence and machine learning (AI/ML) and, more particularly, to task-aware information hiding AI/ML models used in wireless communications.

### BACKGROUND

Unless otherwise indicated herein, approaches described in this section are not prior art to the claims listed below and are not admitted as prior art by inclusion in this section.

In the context of AI/ML, the concept of “information hiding” refers to the action of stuffing covert information into a container using an algorithm or an AI/ML model. The notion of a “container” refers to the host data (e.g., image, text, video frame, and so on) that needs to be transferred to a destination in a network. Moreover, the notion of “hiding information” refers to information for brevity, which is a piece of information that needs to be embedded into a container covertly. In designing an AI/ML model for information hiding, the primary design objectives typically pertain to capacity, robustness, and security. Here, capacity pertains to the amount of embedded data; robustness pertains to the ability to resist against distortions in a transmission channel; and security pertains to the ability of being undetectable by steganalysis.

However, there remain certain challenges that needs to be addressed or resolved. One challenge is related to task unawareness in existing solutions. Another challenge is related to shortcoming of similarity metrics in joint loss. Therefore, there is need for a solution of task-aware information hiding AI/ML models used in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to task-aware information hiding AI/ML models used in wireless communications. Implementations of the proposed schemes may involve increasing the capacity (e.g., data transmitted) by handing over the security aspect to other communication layers. It is believed that implementations of the various proposed schemes may address or otherwise alleviate the aforementioned issue(s). The various schemes proposed herein may be utilized in a variety of applications and scenarios such as, for example and without limitation, CSI compression, denoising (or noise reduction), quantization, coding, error correction codes, modulation, peak-to-average power ratio (PAPR) reduction, and image compression.

In one aspect, a method may involve performing task-aware information hiding or partial task-aware information hiding using an information hiding AI/ML model to embed information in a host data as a container. The method may also involve communicating with a network using the container containing the embedded information.

In another aspect, an apparatus may include a transceiver configured to communicate wirelessly and a processor coupled to the transceiver. The processor may perform task-aware information hiding or partial task-aware information hiding using an information hiding AI/ML model to embed information in a host data as a container. The processor may also communicate with a network using the container containing the embedded information.

It is noteworthy that, although description provided herein may be in the context of certain radio access technologies, networks, and network topologies for wireless communication, such as 5th Generation (5G)/New Radio (NR) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example structure of information hiding AI/ML models.

FIG. 3 is a diagram of example variants of information hiding AI/ML models.

FIG. 4 is a diagram of an example task unawareness in existing solutions.

FIG. 5 is a diagram of an example shortcoming of similarity metrics in joint loss.

FIG. 6 is a diagram of an example design under a proposed scheme in accordance with the present disclosure.

FIG. 7 is a diagram of an example design under a proposed scheme in accordance with the present disclosure.

FIG. 8 is a block diagram of an example communication system in accordance with an implementation of the present disclosure.

FIG. 9 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to task-aware information hiding AI/ML models used in wireless communications. According to the present disclosure, a number of possible solutions may be implemented separately or jointly. That is, although these possible solutions may be described below separately, two or more of these possible solutions may be implemented in one combination or another.

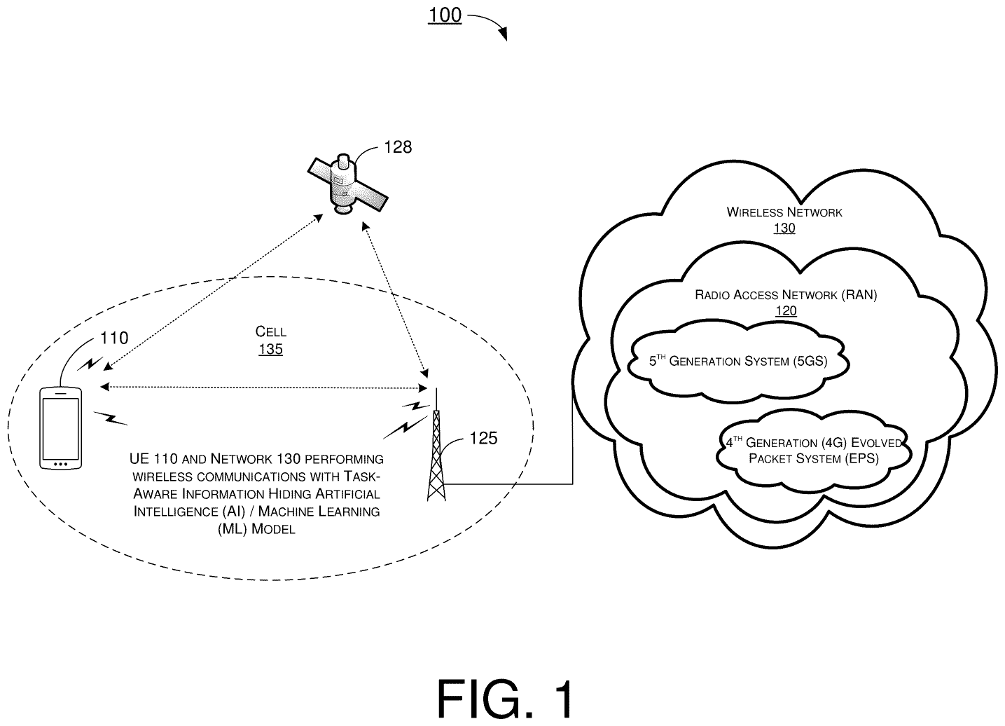

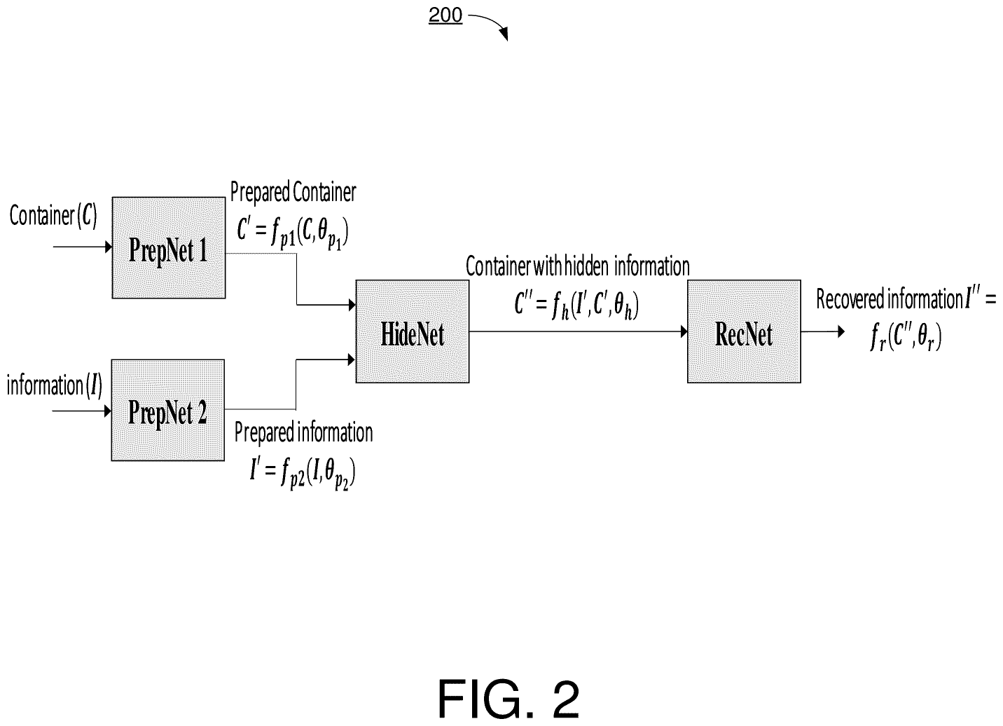

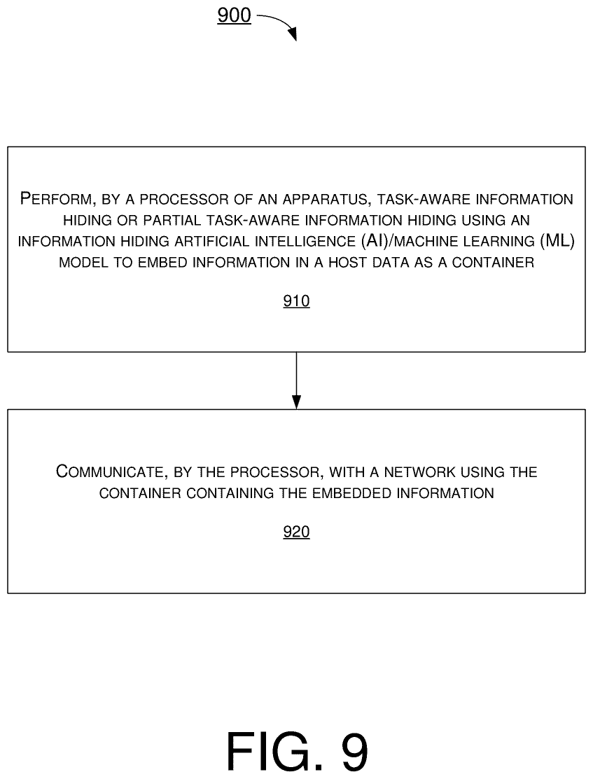

FIG. 1 illustrates an example network environment 100 in which various solutions and schemes in accordance with the present disclosure may be implemented. FIG. 2˜FIG. 9 illustrate examples of implementation of various proposed schemes in network environment 100 in accordance with the present disclosure. The following description of various proposed schemes is provided with reference to FIG. 1˜ FIG. 9.

Referring to FIG. 1, network environment 100 may involve a user equipment (UE) 110 in wireless communication with a radio access network (RAN) 120 (e.g., a 5G NR mobile network or another type of network such as a non-terrestrial network (NTN)). UE 110 may be in wireless communication with RAN 120 via a terrestrial network node 125 (e.g., base station, eNB, gNB or transmit-and-receive point (TRP)) or a non-terrestrial network node 128 (e.g., satellite) and UE 110 may be within a coverage range of a cell 135 associated with terrestrial network node 125 and/or non-terrestrial network node 128. RAN 120 may be a part of a network 130. In network environment 100, UE 110 and network 130 (via terrestrial network node 125 and/or non-terrestrial network node 128) may implement various schemes pertaining to task-aware information hiding AI/ML models used in wireless communications, as described below. In the present disclosure, the task-aware information hiding AI/ML model may be under training for the application(s) of CSI compression, noise reduction, quantization, coding, error correction codes, modulation, PAPR reduction, and/or image compression, among others. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

FIG. 2 illustrates an example structure 200 of information hiding AI/ML models. The structure of an information hiding AI/ML model typically involves a preparation network (PrepNet), a hiding network (HideNet) and a recovery network (RecNet), as shown in FIG. 2. The preparation network translates either the container or information to an intermediate domain which is suitable for information hiding. The hiding network embeds the information into its container. The recovery network recovers the information which is hidden in the container.

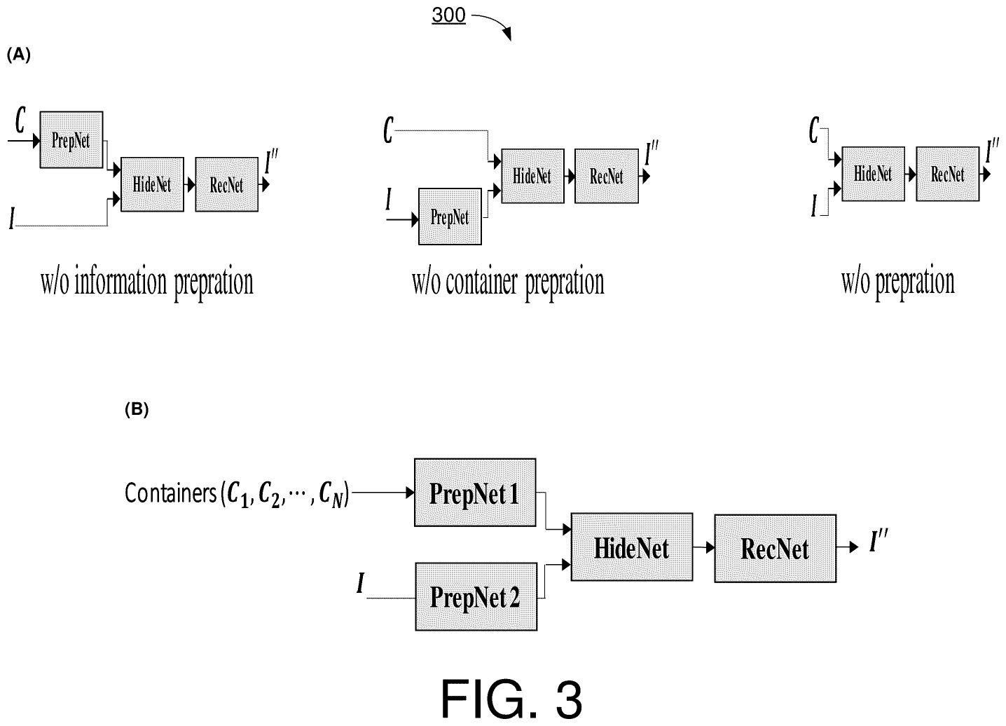

FIG. 3 illustrates an example 300 of variants of information hiding AI/ML models. Regarding variants of information hiding AI/ML models, one variant relates to the usage of PrepNets and another variant relates to the number of containers. Regarding the usage of PrepNets, referring to part (a) of FIG. 3, AI/ML models may feed a container or information directly to HideNet without any PrepNet (e.g., without information preparation, without container preparation, or without any preparation). Regarding the number of containers, referring to part (B) of FIG. 3, the information can be embedded in one or multiple containers, as this can provide robustness if the same information is embedded in more than one container as well as security as it can reduce information size embedded in each container.

However, there remain certain challenges that needs to be addressed or resolved, as described below.

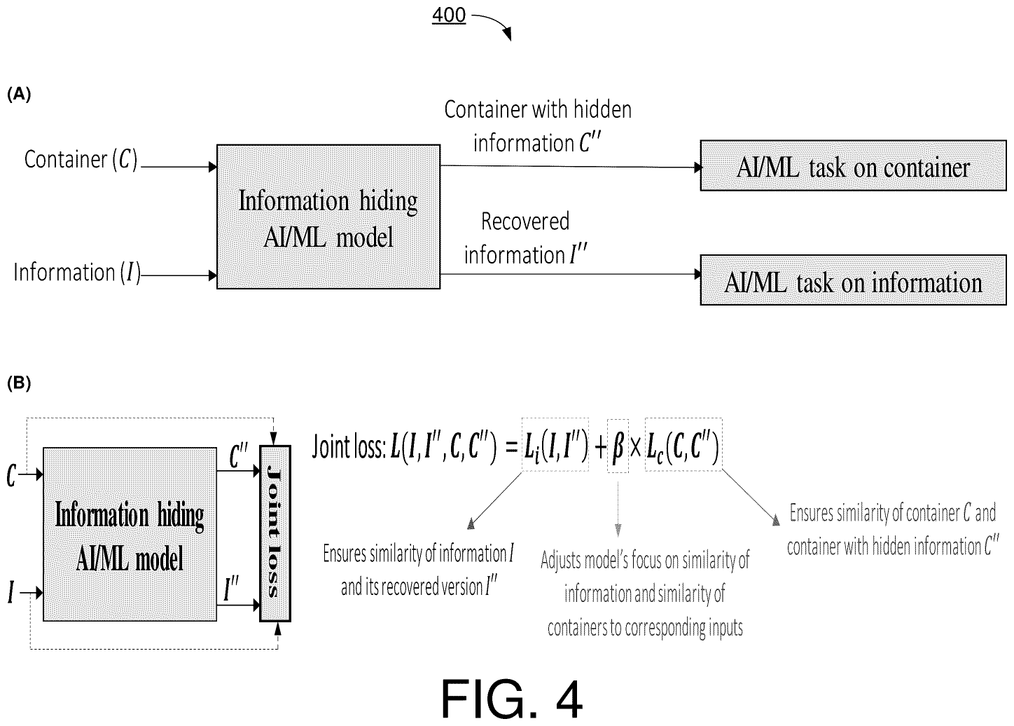

FIG. 4 illustrates an example 400 of task unawareness in existing solutions. One challenge is that existing solutions tend to suffer from task unawareness. With the PrepNets, HideNets, and RecNets assumed or considered as an AI/ML model in whole, usually there are subsequent AI/ML tasks leveraging recovered information and container, as shown in part (A) of FIG. 4. In the training stage, the AI/ML model is trained regardless of subsequent AI/ML tasks, as shown in part (B) of FIG. 4. That is, the AI/ML model is trained with a focus on similarity metrics without considering final AI/ML tasks on container or information. As such, similarity is a task-blind strict metric and may be unnecessary.

Another challenge pertains to shortcoming of similarity metrics in joint loss. Specifically, the concept behind similarity metrics is that any component (e.g., elements in a tensor) of container/information is equally important as other components (but it is unsure whether this is the case from the perspective of an AI/ML model). One example of task-dependent importance of elements of containers pertains to classification/object detection in that, if a dog is a class in an image of a dog on a lawn, data can be aggressively embedded in other part(s) of the image such as grass without affecting AI/ML task on container. Another example of task-dependent importance of elements of containers pertains to annotation in that, in an image of a chainsaw with a white background, the white background is not important in annotating and can be used for information hiding. Yet another example of task-dependent importance of elements of containers pertains to segmentation in that, in two side-by-side images with one image being an original photograph and another image being a color-treated image of the photograph, only edges of objects are important and not the inner sides, as inner part of objects and background can be used for information hiding. Still another example of task-dependent importance of elements of containers pertains to translation in that, in a digitized image of an AI/ML model's attention on an English word in translation in French, not all words are equally important and the unimportant one(s) can be distorted by information hiding.

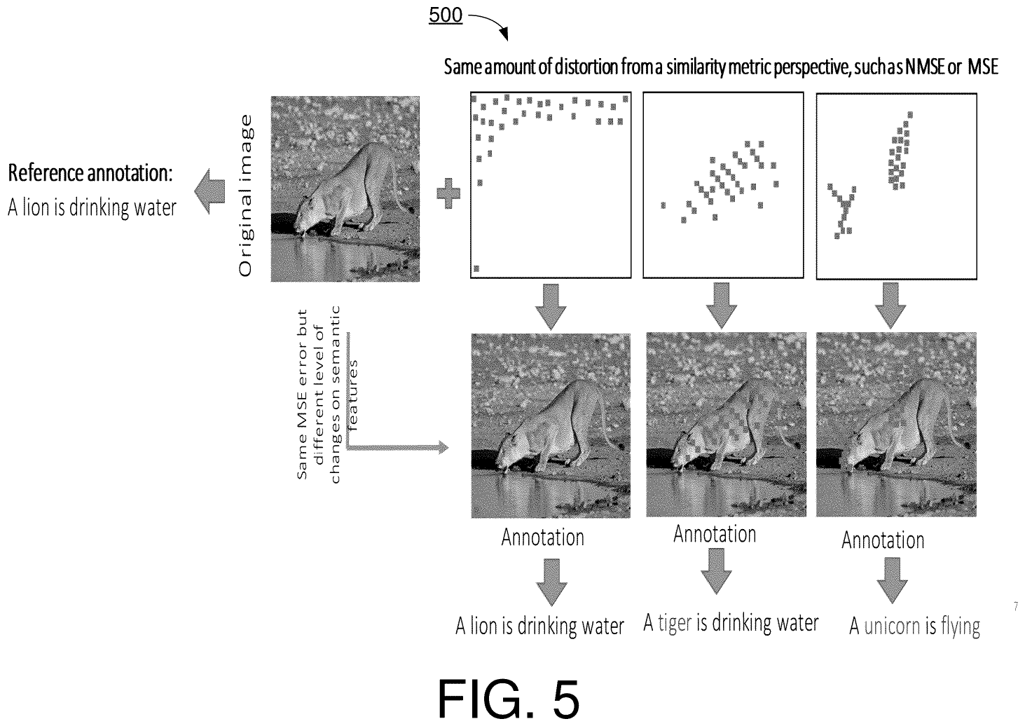

FIG. 5 illustrates an example 500 of shortcoming of similarity metrics in joint loss. One other shortcoming of similarity metrics in joint loss pertains to task-dependent distortion of elements of containers from information hiding. That is, while similarity metric views the place of distortions created by information hiding equally important, the distortion place means much more by the AI/ML task on the container. Referring to the example shown in FIG. 5, given an original image of a lion drinking water and a reference annotation of “a lion is drinking water”, with the same mean-square error (MSE) but different levels of changes on semantic features, the same amount of distortion from a similarity metric perspective (e.g., MSE or normalized MSE (NMSE)) may result in different annotations such as “a lion is drinking water”, “a tiger is drinking water” or “a unicorn is flying.”

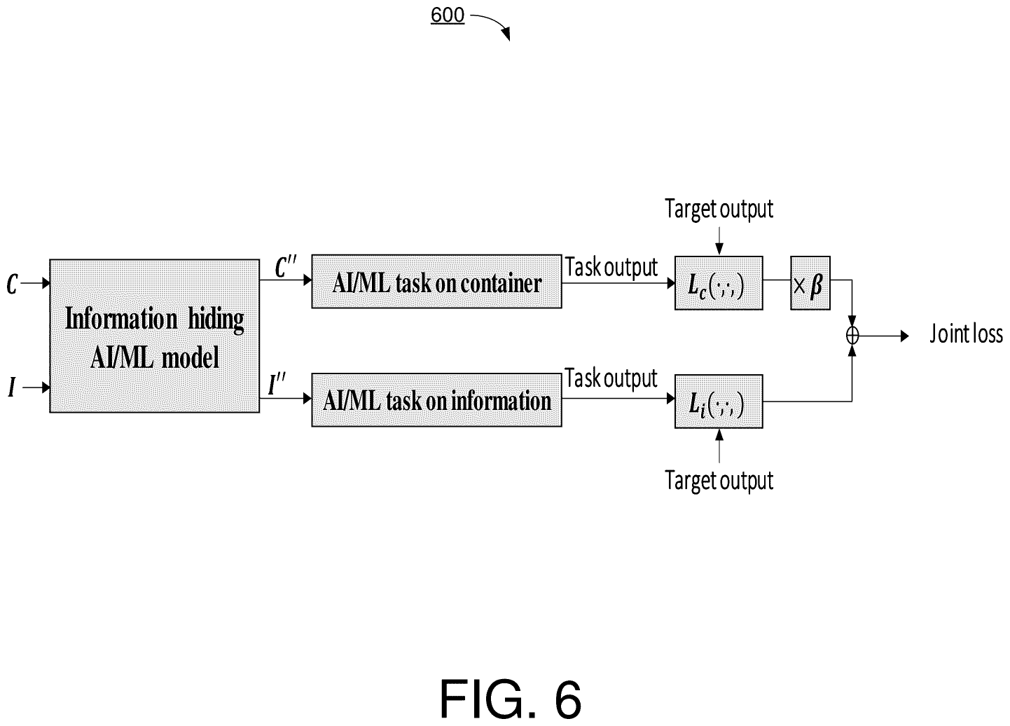

FIG. 6 illustrates an example design 600 under a proposed scheme in accordance with the present disclosure. Under the proposed scheme, task-aware information hiding may be performed. For instance, information on the part(s) not affecting the AI/ML task(s) working on a container, C, may be hidden. Referring to FIG. 6, task output on the container may include a soft output generated by an AI/ML task on C″ (e.g., classification probabilities, word embedding, altered images, and the like). Additionally, task output on information, I, may include a soft output generated by an AI/ML task on/“. Moreover, target output of task on container, L_{c}(.,.), may include an expected output of an AI/ML task on container for a known input if it works on C. The task output and target output are compared together to calculate a loss (herein referred to as “first loss” and “loss regarding container”) with respect to the container. An adjustment function, β, may be applied to the first loss. Furthermore, target output of task on information, Lᵢ(.,.), may include an expected output of an AI/ML task on information for a known input if it works on I. The task output and target output are compared together to calculate a loss (herein referred to as “second loss” and “loss regarding information”) with respect to the information. The first loss (after adjustment to change a focus on similarity) and second loss may then be combined to produce a joint loss. In design 600, C″ denotes container with hidden information, I″ denotes recovered information, and β denotes an adjustment function on the AI/ML model's focus on similarity of information and similarity of containers to corresponding inputs. Moreover, β has the same functionality as before, and both Lᵢ(.,.) and L_{c}(.,.) are similarity but with different arguments.

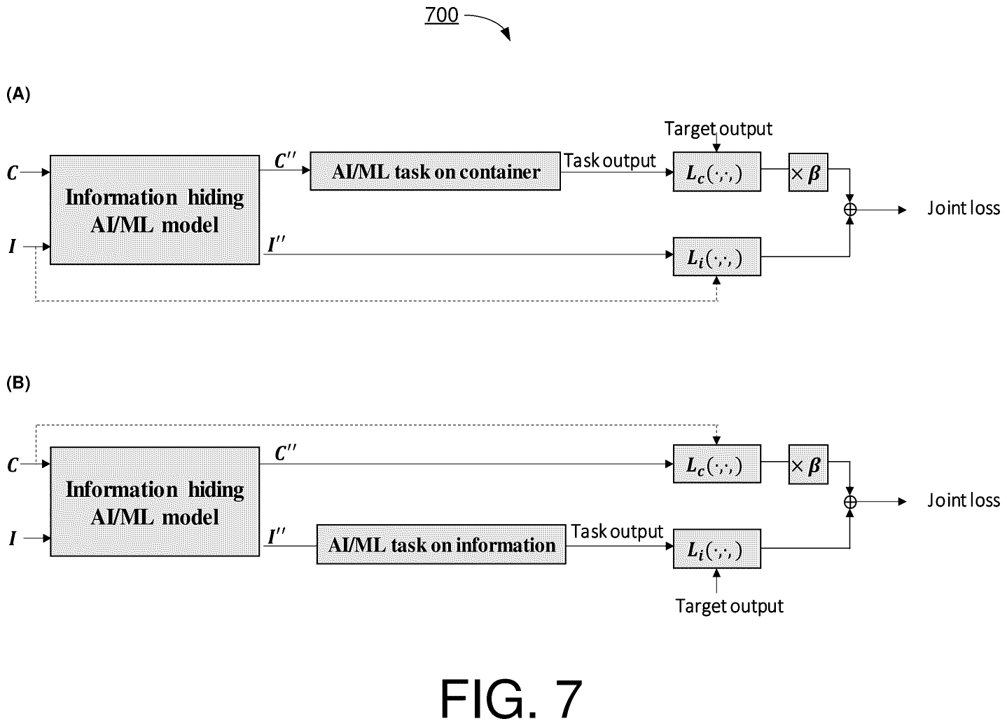

FIG. 7 illustrates an example design 700 under a proposed scheme in accordance with the present disclosure. Under the proposed scheme, partial task-aware information hiding may be performed. For instance, the partial task-aware information hiding may pertain to task-awareness on container only or task-awareness on information only. Referring to part (A) FIG. 7, the task on a container may be known but the usage of information may be kept very general. That is, under one variation of the proposed scheme for partial task-aware information hiding, only unimportant (or relatively less important) part(s) of the container may be used for information hiding. Compared to design 600, in this variation of design 700, the AI/ML task may be performed on the container (e.g., task-awareness on container only) but not on the information. Referring to part (B) of FIG. 7, the task on information may be known but the usage of container may be kept very general. That is, under another variation of the proposed scheme for partial task-aware information hiding, only important (or relatively more important) part(s) of the information may be hidden in the container. Compared to design 600, in this variation of design 700, the AI/ML task may be performed on the information (e.g., task-awareness on information only) but not on the container.

### Illustrative Implementations

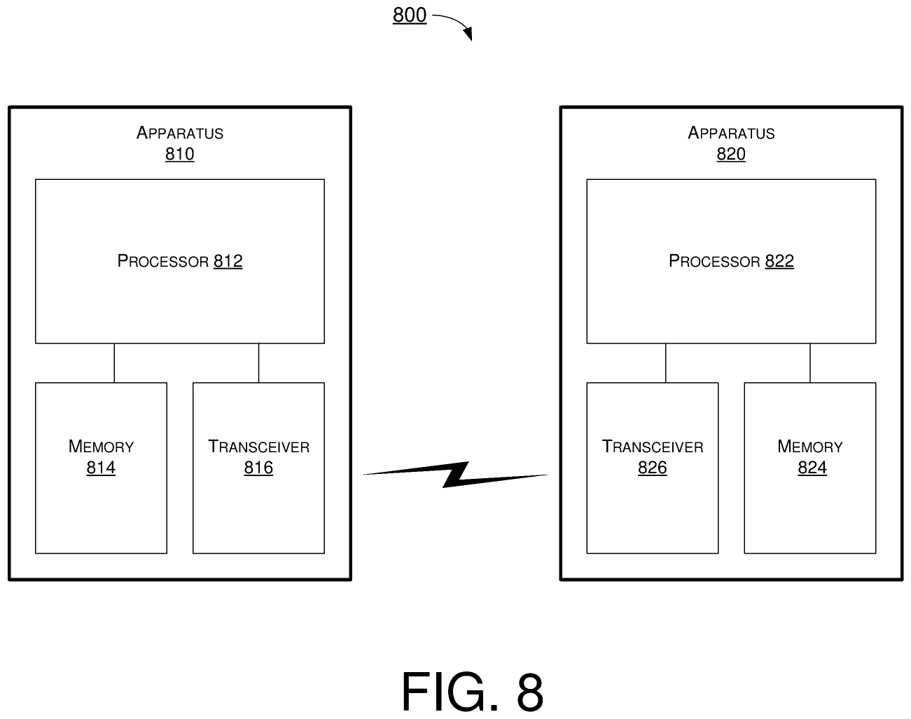

FIG. 8 illustrates an example communication system 800 having at least an example apparatus 810 and an example apparatus 820 in accordance with an implementation of the present disclosure. Each of apparatus 810 and apparatus 820 may perform various functions to implement schemes, techniques, processes and methods described herein pertaining to CSI compression and decompression, including the various schemes described above with respect to various proposed designs, concepts, schemes, systems and methods described above, including network environment 100, as well as processes described below.

Each of apparatus 810 and apparatus 820 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 810 and apparatus 820 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 810 and apparatus 820 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 810 and apparatus 820 may be implemented in a smart thermostat, a smart fridge, a smart door lock, a wireless speaker or a home control center. When implemented in or as a network apparatus, apparatus 810 and/or apparatus 820 may be implemented in an eNodeB in an LTE, LTE-Advanced or LTE-Advanced Pro network or in a gNB or TRP in a 5G network, an NR network or an IoT network.

In some implementations, each of apparatus 810 and apparatus 820 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 810 and apparatus 820 may be implemented in or as a network apparatus or a UE. Each of apparatus 810 and apparatus 820 may include at least some of those components shown in FIG. 8 such as a processor 812 and a processor 822, respectively, for example. Each of apparatus 810 and apparatus 820 may further include one or more other components not pertinent to the proposed scheme of the present disclosure (e.g., internal power supply, display device and/or user interface device), and, thus, such component(s) of apparatus 810 and apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC or RISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including those pertaining to task-aware information hiding AI/ML models used in wireless communications in accordance with various implementations of the present disclosure.

In some implementations, apparatus 810 may also include a transceiver 816 coupled to processor 812. Transceiver 816 may be capable of wirelessly transmitting and receiving data. In some implementations, transceiver 816 may be capable of wirelessly communicating with different types of wireless networks of different radio access technologies (RATs). In some implementations, transceiver 816 may be equipped with a plurality of antenna ports (not shown) such as, for example, four antenna ports. That is, transceiver 816 may be equipped with multiple transmit antennas and multiple receive antennas for multiple-input multiple-output (MIMO) wireless communications. In some implementations, apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs/wireless networks of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications.

In some implementations, apparatus 810 may further include a memory 814 coupled to processor 812 and capable of being accessed by processor 812 and storing data therein. In some implementations, apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of apparatus 810 and apparatus 820 may be a communication entity capable of communicating with each other using various proposed schemes in accordance with the present disclosure. For illustrative purposes and without limitation, a description of capabilities of apparatus 810, as a UE (e.g., UE 110), and apparatus 820, as a network node (e.g., network node 125) of a network (e.g., network 130 as a 5G/NR mobile network), is provided below in the context of example process 900.

### Illustrative Processes

FIG. 9 illustrates an example process 900 in accordance with an implementation of the present disclosure. Process 900 may represent an aspect of implementing various proposed designs, concepts, schemes, systems and methods described above pertaining to task-aware information hiding AI/ML models used in wireless communications, whether partially or entirely, including those pertaining to those described above. Process 900 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Process 900 may be implemented by or in apparatus 810 and/or apparatus 820 as well as any variations thereof. Solely for illustrative purposes and without limiting the scope, each process is described below in the context of apparatus 810 as a UE (e.g., UE 110) and apparatus 820 as a communication entity such as a network node or base station (e.g., terrestrial network node 120) of a network (e.g., a 5G/NR mobile network). Process 900 may begin at block 910.

At 910, process 900 may involve processor 812 of apparatus 810 (e.g., as UE 110) performing task-aware information hiding or partial task-aware information hiding using an information hiding AI/ML model to embed information in a host data as a container. Process 900 may proceed from 910 to 920.

At 920, process 900 may involve processor 812 communicating, via transceiver 816, with a network (e.g., network 130 via apparatus 820 as terrestrial network node 125 or non-terrestrial network node 128) using the container containing the embedded information.

In some implementations, in performing the task-aware information hiding, process 900 may involve processor 812 hiding a part of the information that does not affect an AI/ML task working on the container.

In some implementations, in performing the task-aware information hiding, process 900 may involve processor 812 performing certain operations. For instance, process 900 may involve processor 812 providing the container (C) and the information (I) to the information hiding AI/ML model to produce a container with hidden information (C″) and recovered information (I″). Also, process 900 may involve processor 812 providing the container with hidden information to an AI/ML task on the container to produce a first task output as a task output on the container. Similarly, process 900 may involve processor 812 providing the recovered information to an AI/ML task on the information to produce a second task output as a task output on the information. Additionally, process 900 may involve processor 812 comparing the first task output with a target output of task on the container to calculate a first loss. Moreover, process 900 may involve processor 812 comparing the second task output with a target output of task on the information to calculate a second loss. Furthermore, process 900 may involve processor 812 combining the first loss and the second loss to produce a joint loss.

In some implementations, the first task output may include a soft output generated by the AI/ML task on the container with embedded information. Also, the second task output may include a soft output generated by the AI/ML task on the recovered information. Moreover, the target output of task on the container may include an expected output of the AI/ML task on the container. Furthermore, the target output of task on the information may include an expected output of the AI/ML task on the information.

In some implementations, in combining the first loss and the second loss, process 900 may involve processor 812, prior to the combining, applying an adjustment function (β) to the first loss to change a focus on similarity.

In some implementations, in performing the partial task-aware information hiding, process 900 may involve processor 812 performing information hiding with task-awareness on the container only or with task-awareness on the information only.

In some implementations, in performing the partial task-aware information hiding, process 900 may involve processor 812 using a relatively less important part of the container in hiding a part of the information that does not affect an AI/ML task working on the container.

In some implementations, in performing the partial task-aware information hiding, process 900 may involve processor 812 performing certain operations. For instance, process 900 may involve processor 812 providing the container (C) and the information (I) to the information hiding AI/ML model to produce a container with hidden information (C″) and recovered information (I″). Also, process 900 may involve processor 812 providing the container with hidden information to an AI/ML task on the container to produce a task output on the container. Additionally, process 900 may involve processor 812 comparing the task output on the container with a target output of task on the container to calculate a first loss. Moreover, process 900 may involve processor 812 comparing the recovered information with a target output of task on the information to calculate a second loss. Furthermore, process 900 may involve processor 812 combining the first loss and the second loss to produce a joint loss.

In some implementations, in performing the partial task-aware information hiding, process 900 may involve processor 812 hiding a relatively more important part of the information in the container.

In some implementations, in performing the partial task-aware information hiding, process 900 may involve processor 812 performing certain operations. For instance, process 900 may involve processor 812 providing the container (C) and the information (I) to the information hiding AI/ML model to produce a container with hidden information (C″) and recovered information (I″). Also, process 900 may involve processor 812 providing the recovered information to an AI/ML task on the information to produce a task output on the information. Additionally, process 900 may involve processor 812 comparing the container with hidden information with a target output of task on the container to calculate a first loss. Moreover, process 900 may involve processor 812 comparing the task output on the information with a target output of task on the information to calculate a second loss. Furthermore, process 900 may involve processor 812 combining the first loss and the second loss to produce a joint loss.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, task-aware information hiding or partial task-aware information hiding using an information hiding artificial intelligence (AI)/machine learning (ML) model to embed information in a host data as a container; and
communicating, by the processor, with a network using the container containing the embedded information.

2. The method of claim 1, wherein the performing of the task-aware information hiding comprises hiding a part of the information that does not affect an AI/ML task working on the container.

3. The method of claim 1, wherein the performing of the task-aware information hiding comprises:
providing the container (C) and the information (I) to the information hiding AI/ML model to produce a container with hidden information (C″) and recovered information (I″);
providing the container with hidden information to an AI/ML task on the container to produce a first task output as a task output on the container;
providing the recovered information to an AI/ML task on the information to produce a second task output as a task output on the information;
comparing the first task output with a target output of task on the container to calculate a first loss;
comparing the second task output with a target output of task on the information to calculate a second loss; and
combining the first loss and the second loss to produce a joint loss.

4. The method of claim 3, wherein:
the first task output comprises a soft output generated by the AI/ML task on the container with embedded information;
the second task output comprises a soft output generated by the AI/ML task on the recovered information;
the target output of task on the container comprises an expected output of the AI/ML task on the container; and
the target output of task on the information comprises an expected output of the AI/ML task on the information.

5. The method of claim 3, wherein the combining of the first loss and the second loss comprises, prior to the combining, applying an adjustment function (β) to the first loss to change a focus on similarity.

6. The method of claim 1, wherein the performing of the partial task-aware information hiding comprises performing information hiding with task-awareness on the container only or with task-awareness on the information only.

7. The method of claim 1, wherein the performing of the partial task-aware information hiding comprises using a relatively less important part of the container in hiding a part of the information that does not affect an AI/ML task working on the container.

8. The method of claim 1, wherein the performing of the partial task-aware information hiding comprises:
providing the container (C) and the information (I) to the information hiding AI/ML model to produce a container with hidden information (C″) and recovered information (I″);
providing the container with hidden information to an AI/ML task on the container to produce a task output on the container;
comparing the task output on the container with a target output of task on the container to calculate a first loss;
comparing the recovered information with a target output of task on the information to calculate a second loss; and
combining the first loss and the second loss to produce a joint loss.

9. The method of claim 1, wherein the performing of the partial task-aware information hiding comprises hiding a relatively more important part of the information in the container.

10. The method of claim 1, wherein the performing of the partial task-aware information hiding comprises:
providing the container (C) and the information (I) to the information hiding AI/ML model to produce a container with hidden information (C″) and recovered information (I″);
providing the recovered information to an AI/ML task on the information to produce a task output on the information;
comparing the container with hidden information with a target output of task on the container to calculate a first loss;
comparing the task output on the information with a target output of task on the information to calculate a second loss; and
combining the first loss and the second loss to produce a joint loss.

11. An apparatus, comprising:
a transceiver configured to communicate wirelessly; and
a processor coupled to the transceiver and configured to perform operations comprising:
performing task-aware information hiding or partial task-aware information hiding using an information hiding artificial intelligence (AI)/machine learning (ML) model to embed information in a host data as a container; and
communicating, via the transceiver, with a network using the container containing the embedded information.

12. The apparatus of claim 11, wherein the performing of the task-aware information hiding comprises hiding a part of the information that does not affect an AI/ML task working on the container.

13. The apparatus of claim 11, wherein the performing of the task-aware information hiding comprises:
providing the container (C) and the information (I) to the information hiding AI/ML model to produce a container with hidden information (C″) and recovered information (I″);
providing the container with hidden information to an AI/ML task on the container to produce a first task output as a task output on the container;
providing the recovered information to an AI/ML task on the information to produce a second task output as a task output on the information;
comparing the first task output with a target output of task on the container to calculate a first loss;
comparing the second task output with a target output of task on the information to calculate a second loss; and
combining the first loss and the second loss to produce a joint loss.

14. The apparatus of claim 13, wherein:
the first task output comprises a soft output generated by the AI/ML task on the container with embedded information;
the second task output comprises a soft output generated by the AI/ML task on the recovered information;
the target output of task on the container comprises an expected output of the AI/ML task on the container; and
the target output of task on the information comprises an expected output of the AI/ML task on the information.

15. The apparatus of claim 13, wherein the combining of the first loss and the second loss comprises, prior to the combining, applying an adjustment function (6) to the first loss to change a focus on similarity.

16. The apparatus of claim 11, wherein the performing of the partial task-aware information hiding comprises performing information hiding with task-awareness on the container only or with task-awareness on the information only.

17. The apparatus of claim 11, wherein the performing of the partial task-aware information hiding comprises using a relatively less important part of the container in hiding a part of the information that does not affect an AI/ML task working on the container.

18. The apparatus of claim 11, wherein the performing of the partial task-aware information hiding comprises:
providing the container (C) and the information (I) to the information hiding AI/ML model to produce a container with hidden information (C″) and recovered information (I″);
providing the container with hidden information to an AI/ML task on the container to produce a task output on the container;
comparing the task output on the container with a target output of task on the container to calculate a first loss;
comparing the recovered information with a target output of task on the information to calculate a second loss; and
combining the first loss and the second loss to produce a joint loss.

19. The apparatus of claim 11, wherein the performing of the partial task-aware information hiding comprises hiding a relatively more important part of the information in the container.

20. The apparatus of claim 11, wherein the performing of the partial task-aware information hiding comprises:
providing the container (C) and the information (I) to the information hiding AI/ML model to produce a container with hidden information (C″) and recovered information (I″);
providing the recovered information to an AI/ML task on the information to produce a task output on the information;
comparing the container with hidden information with a target output of task on the container to calculate a first loss;
comparing the task output on the information with a target output of task on the information to calculate a second loss; and
combining the first loss and the second loss to produce a joint loss.
